(19) United States
(12) Patent Application Publication
(10) Pub. No.: US 2019/0087836 A1
(43) Pub. Date: Mar. 21, 2019

(54) METHOD AND SYSTEM OF FACILITATING REGISTRATION OF A USER

(71) Applicant: Instant Info LLC, Somerset, NJ (US)

(72) Inventors: Sivaraman Anbarasan, Somerset, NJ (US); John Piechnik, Morristown, NJ (US); Murty Korada, East Windsor, NJ (US)

(21) Appl. No.: 16/133,416

(22) Filed: Sep. 17, 2018

Related U.S. Application Data
(60) Provisional application No. 62/559,634, filed on Sep. 17, 2017.

(51) Int. Cl. G06Q 30/02; G06F 17/30; G06F 17/24; H04W 4/14

(52) U.S. Cl. CPC G06Q 30/0201; H04W 4/14; G06F 17/243; G06F 17/30979

(57) ABSTRACT

Disclosed is a method of facilitating registration of a user. The method may include assigning a plurality of institution identifiers to a plurality of institutions corresponding to an organized event represented by a unique event code. Further, the method may include receiving a unique institution identifier associated with an institution of the plurality of institutions from a user device associated with the user. Further, the method may include receiving a user identifier from the user device. Further, the method may include transmitting an electronic form to the user device. Further, the method may include receiving a filled electronic form from the user device. Further, the method may include creating a user profile based on the user data. Further, the method may include storing the user profile in association with the unique institution identifier and the unique event code in a database of user profiles.

### FIELD OF THE INVENTION

The present disclosure relates generally to the field of data processing. More specifically, the present disclosure relates to registering users.

### BACKGROUND OF THE INVENTION

There are many types of events on a regular basis for many industries that are held with the particular objective of sharing marketing and informational material about a particular entity with attendees. Conferences and fairs are a few examples of such events. Fairs such as college fairs, job fairs, and military recruitment fairs are a few examples of fairs that are heavily attended on an ongoing basis by interested participants.

In the case of college fairs, a college fair is a gathering where prospective students come usually to obtain information about a college, university, or other learning facility of interest to the students as well as to interact with recruiters or other admissions representatives from different colleges. Many college fairs are conducted every year in many locations. Many colleges (usually 50-200) participate in these college fairs to provide information about their curriculum, activities, and specialties. Interested students may attend from nearby or not too distant high schools to learn about the higher education opportunities at the participating colleges.

Participating colleges typically send at least one or more representatives to the college fairs who are stationed at a booth so that interested students may approach the representative and find out more information about the college. The college representatives are often also referred to as counselors and/or recruiters. These college representatives usually carry college information brochures and advertising material about the college. Additionally, an important part of the representatives' job is to also provide, what are known as, “information collection cards. When an interested student approaches the representative and asks for more information or to be included in the admissions contact database, the representative usually hands the student an information collection card. The information collection card may also be referred to as a sign-up or registration card. The student is responsible for correctly filling out and providing his or her contact information on the card. Typically, an information collection card includes spots where a student may include his or her name, telephone number, email address, and/or physical address. In addition, some cards may also ask about identifying characteristics about the student such as their gender and age, as well as ask them to provide areas of study and activities in which they may be interested, the high school that they attend, or the like. It is then the responsibility of the college representative to collect the filled information collection cards and return them to the college admissions office. Either the representative himself or herself or another data entry operator assigned this role enters the data from the information collection cards into the college database. Sometimes, the data entry operator may use a software application such as “Candidate Information Software,” which is a type of recruitment software that organizes and manages contact information from prospective recruits. Alternatively, the data from the information collection cards is entered and stored into other databases and files dedicated to this type of information.

This has been the typical approach for many years. On occasion, a college recruiter or representative may also hand out business cards or flyers to interested students instructing the student to sign up for more information from the college's website. However, there are many deficiencies and downsides with the conventional methods of receiving a student's contact information or registering to receive further information.

For starters, students mostly handwrite their information whether on an information collection card or some other type of sign-up sheet. The contact information that is included on a sign-up sheet is often hard to read or illegible. Just as problematic, the collection card may be missing data if the student did not take the time to hand write all the asked for information. The process of transcribing or transferring hundreds of student names, email addresses, and telephone numbers is fraught with potential for error. It may be quite difficult to transfer the contact information from the card in a manner that is useful and accurate. Further, it is quite common for a recruiter or admissions representative to make mistakes in typing when transcribing the information from the sign-up card or registration sheet even if the handwriting is legible. The mistakes in contact information that are then stored have many undesirable consequences. If a student is receiving digital mail via email, and his or her email is misspelled, the student does not receive the relevant information from the college. With respect to physical mailing addresses, if the data entry operator misspelled or incorrectly typed out the physical mailing address, any information that is mailed by post to the student is likely to be returned and rejected, which is a waste of time and money.

Because the collection card is still a highly used way of collecting student contact information and data, the college representative must be sure to pre-order a sufficient number of information collection cards to have on hand at the fair. Therefore, the college recruiter must have a good estimate of how many students may attend the fair. This requires a lot of planning and dependency on card printing vendors and effective logistics. A recruiter or counselor may travel to more than one fair in a row or in a few days and must be sure to carry many of these cards which may become heavy and take up weight in their luggage.

It is noted that in addition to the problems listed above with the standard information collection cards used at college fairs (or other types of events), it is repetitive, boring, and tiring for the student to continuously fill out a different card for each college or other type of entity that the student may be interested in learning more about or attending. Also, a student may not want to wait or queue up in a line at table or booth to meet with a counselor to fill out the information collection card.

An additional challenge is that there is no tracking system for any of these cards. It is very easy for a small or large number of these cards to be lost by a college representative inadvertently. Further, the contact information from these cards is not usually transcribed until at least few days or more from the date of the actual event. There are many instances where the cards are not reviewed and the information located therein is not transcribed or transferred to an appropriate place until weeks or months after a fair (or other event) has taken place. By this time, the recruiter or representative will have probably forgotten any special notes or information about the student, and there may have been too much time that has elapsed such that the person who was once interested in the college is no longer available.

Some college booths also provided referral cards that include Quick Response (QR) code. A QR code is a type of scannable code (similar to a barcode) where a particular type of information is displayed when the QR code is scanned (i.e. “read). In this particular example, a college recruiter may have material that includes a QR code to be handed out to students. In order to read the QR code, the user's smartphone device either has to have an integrated application that can read the QR code or the user must separately download a QR code application to do so, and the QR codes must be created and then registered as an operational code to the website which it is associated with. Either way, by reading the QR code of from the informational material provided by the recruiter, the user is solely directed to that college's website or a page to enter in their identifying information.

Similarly, many colleges will have basic promotional material that includes their web addresses or links that are either handed out to students or made very visible at the college booth. The interested student must still take the initiative to go to the website and fill out the necessary applications and forms to enter their contact information so that the college knows to contact them and send them informational material.

The current system adopted by many college recruitment fairs and other similar types of large gatherings that register a large quantity of users and are intended to capture contact information from attendees is very time consuming, error prone, inaccurate, and an inefficient system for both the attendees and recruiters or other representatives. In light of the above, there still exists a need for providing a better way of capturing data from users at large gatherings, in particular, events that are focused on recruiting the attendees, such as, but not limited to, college fairs, job fairs, military recruitment fairs, sporting events, or any other type of event.

Therefore, there is a need for improved methods and systems for facilitating registration of users that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a method of facilitating registration of a user is disclosed. The method may include assigning, using a processing device, a plurality of institution identifiers to a plurality of institutions corresponding to an organized event represented by a unique event code. Further, the method may include receiving, using a communication device, a unique institution identifier associated with an institution of the plurality of institutions from a user device associated with the user. Further, the method may include receiving, using the communication device, a user identifier from the user device. Further, the user identifier may be associated with the user. Further, the method may include transmitting, using the communication device, an electronic form to the user device. Further, the electronic form may be configured to be presented on the user device. Further, the method may include receiving, using the communication device, a filled electronic form from the user device. Further, the filled electronic form may include user data corresponding to the user. Further, the method may include creating, using the processing device, a user profile based on the user data. Further, the method may include storing, using the storage device, the user profile in association with the unique institution identifier and the unique event code in a database of user profiles.

According to some embodiments, a system for facilitating registration of a user is also disclosed. The system may include a processing device configured for assigning, using a processing device, a plurality of institution identifiers to a plurality of institutions corresponding to an organized event. Further, the processing device may be configured for creating a user profile based on user data. Further, the system may include a communication device configured for receiving, a unique institution identifier associated with an institution of the plurality of institutions from a user device associated with the user. Further, the communication device may be configured for receiving a user identifier from the user device. Further, the user identifier may be associated with the user. Further, the communication device may be configured for transmitting an electronic form to the user device. Further, the electronic form may be configured to be presented on the user device. Further, the communication device may be configured for receiving a filled electronic form from the user device. Further, the filled electronic form may include the user data corresponding to the user. Further, the system may include a storage device configured for storing the user profile in association with the unique institution identifier in a database of user profiles.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating registration of a user in accordance with some embodiments.

FIG. 3 is a flowchart of a method of facilitating registration of a user in accordance with some embodiments.

FIG. 4 is a flowchart of a method of searching users accordance with some embodiments.

FIG. 5 is a flowchart of a method of receiving text messages related to institutions in accordance with some embodiments.

FIG. 6 is a flowchart of a method of sending information related to institutions to users in accordance with some embodiments.

FIG. 7 is a flowchart of a method of obtaining data analytics in accordance with some embodiments.

FIG. 8 is a block diagram of an exemplary system for collecting user data from a user who is attending or participating in an event, in accordance with some embodiments.

FIG. 9 is a flowchart for an exemplary method for collecting student data and registering users to receive information from participating academic institutions attending an event in accordance with some embodiments.

FIG. 10 is a user interface related to confirmation messages received in a process for collecting student data and registering students with specific colleges of interest in accordance with an exemplary embodiment.

FIG. 11 is a user interface related to an exemplary fillable user data form for receiving student data in accordance with an exemplary embodiment.

FIG. 12 is a user interface related to an exemplary confirmation message in accordance with an exemplary embodiment.

FIG. 13 is a user interface related to a registered student receiving confirmation of registration with another college after an initial student profile is created in accordance with an exemplary embodiment.

FIG. 14 is a flowchart of an exemplary method for collecting user data and registering users to receive information or services from participating entities at an event in accordance with some embodiments.

FIG. 15 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Therefore, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of collecting user data, embodiments of the present disclosure are not limited to use only in this context.

### Overview

According to some embodiments, a system and method is provided for associating students with a set of academic institutions attending an organized event for the set of academic institutions is disclosed. The disclosed systems and methods include receiving a first text message from a student's computing device, whereby the first text message includes a first identifier associated with a first academic institution of the set of academic institutions. A web link is sent to the at least one computing device. The web link includes a web-based form that is configured to collect student data such as the student's contact information or other identifying characteristics. The form containing the student data is received and stored in association with a profile for the student. The student data is provided to the first academic institution so that the first academic institution may contact the student. Responsive to receiving additional text messages from the student, confirmation messages are sent and the student does not have to fill out any additional forms to receive information from the additional academic institutions.

Further, some embodiments for a system and method are provided to facilitate user registration. In particular, the embodiments are directed to a system and method that allows for quick, accurate registration of a user, particularly, a student interested in obtaining information from an entity, such as a college, university, or any other type of entity that may participate in an organized event.

Further, the present disclosure is generally drawn to one or more embodiments for a system and a method for collecting user data and registering users to receive information and/or receive services offered by one or more entities attending or participating in an organized event. Further, the present disclosure includes one or more embodiments for a web-based or cloud application that operates to collect users contact information and other related data by, among other steps, sending a web-based fillable form designed to obtain user's contact information that may be filled out from a user's digital computing device. A cloud application, as described herein, may be executed and utilized on any type of computing device associated with a user, including, but not limited to, smartphones or other digital devices such as laptops, tablets, notebooks, smartwatches, etc.

There are many applications and instances where one or more embodiments of a system and method in the present disclosure may be used. For example, and without limitation thereto, it may particularly advantageous to use embodiments of the system and method described in the present disclosure to collect student data and to register a student to receive information, such as (without limitation thereto) promotional, marketing, and/or or admissions related material from a college that the student has a desire to learn about and to possibly attend.

Further, there are numerous drawbacks in the existing methods used at college fairs for obtaining student contact information and then entering that student's contact information. The conventional methods are outdated and inefficient and cumbersome for both students interested in acquiring information from multiple colleges and for the college admissions' representatives as well. Therefore, it is an object of the present disclosure to provide a more user-friendly, efficient, and accurate method and system, in accordance with one or more embodiments, to register a student to receive informational materials, including admissions applications or the like, from a college or other type of academic institution.

Accordingly, in one embodiment of a method for collecting a student's contact information and other related data may include assigning an identifier to each participating academic institution attending an organized event. Further, a web application may be utilized that is retrievable and accessible to a student or other user over using a network that includes various protocols known to one of ordinary skill in the art. In one or more embodiments, a student may utilize his or her digital computing device (e.g. smartphones, tablets, laptops, wearable watches or glasses or other technology, etc.) to send a text message to the particular telephone number. The text message may further contain in the message the unique identifier for a particular college or other academic institution of interest.

In response, the system may make a determination whether the student is a first time user or whether the student already has an existing user profile. If the student is a first time user and does not have an existing user profile, then the process may include sending a web link to the student. The web link may be selected by the student, which upon being received by a web browser on the student's computing device, may direct a student to a web-based fillable form.

In one or more embodiments, the web-based fillable form may include fields that ask for basic contact information from the student such as student name, email addresses, telephone numbers, physical addresses. These items may be the most basic set of questions included in the form. In addition, there may be fields for additional relevant data that a college may be interested in obtaining from a student such as high school that he or she attended, age of the student, areas of study that the student is interested in attending, gender, race/ethnicity, age, as well as any other type of relevant questions.

Further, the process may continue with the student submitting the completed form. Subsequently, the student's profile is created and associated with the student's computing device and/or other devices in alternative embodiments. Following this non-limiting exemplary process, a student may be registered (i.e. subscribed) to receive further information from a particular academic institution of interest to the student.

In yet another aspect of the present invention, embodiments are provided for registering a user to receive information and services from entities, other than academic institutions. Examples of such entities include, but are not limited to business entities participating in a job fair, non-profit organizations participating in a community-oriented service event, or branches of the military that participate in military recruiting fairs. A process and system, according to embodiments in the present disclosure, for collecting user data for non-academic entities is also provided that is similar to the process and system described above.

According to an embodiment, a system for collecting student data is disclosed. The system may include at least one computing device, wherein the at least one computing device is associated with a student attending an organized event, wherein the organized event includes an attendance of a set of academic institutions. The system may include a network. Further, the system may include an application located on one or more data processing units, wherein the data processing units include one or more storage devices storing instructions that are operable, when executed by the one or more data processing units to cause the one or more data processing units to perform operations comprising associating a phone number with the application, associating an identifier with each academic institution of the set of academic institutions, receiving a first text message from the at least one computing device that is texted to the phone number associated with the application, wherein the text message comprises a first identifier that is associated with a first academic institution of the set of academic institutions, responsive to receiving the first text message from the at least one computing device, sending a web link to the at least one computing device, wherein the web link directs the student to a form, the form comprising fillable fields configured to collect student data, wherein the student data comprises the student's contact information or other identifying characteristics, receiving the form containing the student data, storing the student data in association with a profile for the student, providing the student data to the first academic institution, wherein the first academic institution contacts the student using the student data and provides further information from the first academic institution, receiving a second text message from the at least one computing device, wherein the second text message comprises a second identifier that is associated with a second academic institution and responsive to receiving the second text message from the at least one computing device, sending a confirmation message that the student is registered to receive information from the second academic institution.

Further, a computer-implemented method for collecting student data is disclosed. The method may include associating an identifier with each academic institution of the set of academic institutions. The method may include receiving a first text message from the at least one computing device that is texted to a phone number associated with an application configured to receive the student data, wherein the text message comprises a first identifier that is associated with a first academic institution of the set of academic institutions. The method may include responsive to receiving the first text message from the at least one computing device, sending a web link to the at least one computing device, wherein the web link directs the student to a form comprising fillable fields configured to collect student data, wherein the student data comprises the student's contact information or other identifying characteristics. The method may include receiving the form containing the student data. The method may include storing the student data in association with a profile for the student. The method may include providing the student data to the first academic institution, wherein the first academic institution contacts the student using the student data and provides further information from the first academic institution. The method may include responsive to receiving additional text messages from the at least one computing device comprising additional identifier associated with additional academic institutions from the set of academic institutions, providing confirmation messages that the student is registered to receive additional information from the additional academic institutions. The method may include providing the student's data to the additional academic institutions.

According to an aspect, one or more non-transitory computer readable medium for collecting user data and registering a user to receive information or services provided by a set of entities at an organized event is provide. The one or more non-transitory computer readable medium comprising computer readable program code that when executed by one or more computers cause the one or more computers to perform operations comprising associating an identifier with each participating entity of a set of entities attending an organized event, wherein the organized event is related to sharing information about or providing services offered by the set of entities, receiving a first text message from a user, wherein the user sends the first text message to a phone number associated with an application configured to receive the user data, wherein the first text message comprises an identifier that is associated with a first entity of the set of entities, responsive to receiving the first text message from the at least one computing device, sending a web link to the user, wherein the web link directs the user to a form comprising fillable fields configured to collect user data, wherein the user data comprises the user's contact information or other identifying characteristics, receiving the form containing the user data, storing the user data in association with a profile for the user, providing the user data to the first entity in order for the first entity to retain the user data, responsive to a determination by the user to continue to register for information or services from additional entities of the set of entities, receiving additional text messages from the user, wherein the additional text messages comprise an identifier for each additional entity, responsive to receiving the additional text messages from the user, sending a confirmation message that the student is registered to receive information or services from the additional entities and providing the user data to the additional entities.

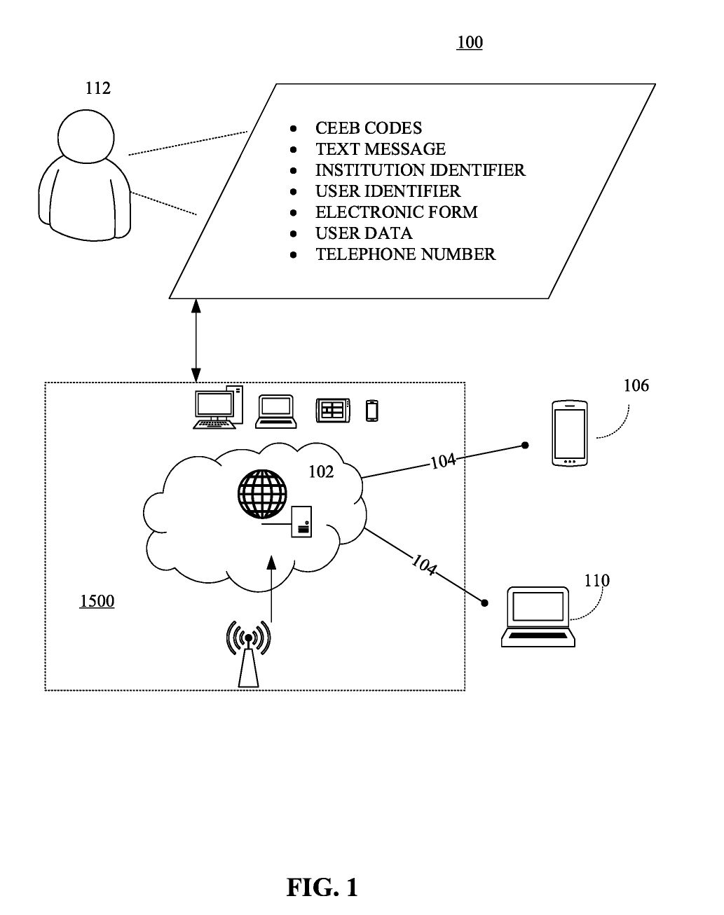

Referring now to figures, FIG. 1 is an illustration of an online platform 100 consistent with various embodiments of the present disclosure. By way of non-limiting example, the online platform 100 for facilitating registration of a user may be hosted on a centralized server 102, such as, for example, a cloud computing service. The centralized server 102 may communicate with other network entities, such as, for example, a mobile device 106 (such as a smartphone), other computing devices 110 (such as desktop computers, server computers, laptops etc.), over a communication network 104, such as, but not limited to, the Internet. Further, users of the online platform 100 may include relevant parties such as, but not limited to, students, teachers, college officials, parents, guardians and administrators. Accordingly, in some instances, electronic devices operated by the one or more relevant parties may be in communication with the platform 100.

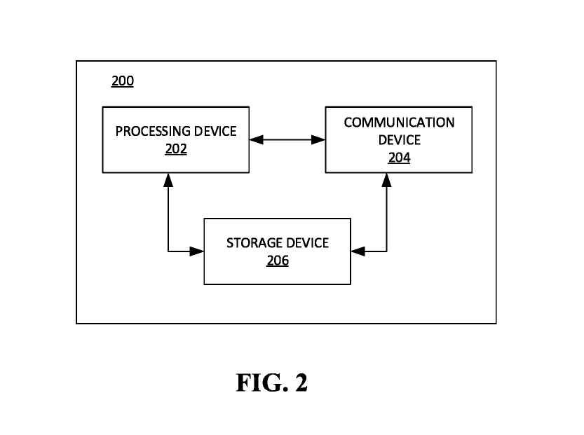

A user 112, such as the one or more relevant parties, may access online platform 100 through a web-based software application or browser. The web-based software application may be embodied as, for example, but not be limited to, a website, a web application, a desktop application, and a mobile application compatible with a computing device 1500. The platform 100 may be configured to communicate with a system 200 for facilitating registration of a user, such as the user 112. The system 200 is explained in detail in conjunction with FIG. 2 below.

FIG. 2 is a block diagram of the system 200 for facilitating registration of a user in accordance with some embodiments. The system 200 may include a processing device 202 configured for assigning, a plurality of institution identifiers to a plurality of institutions corresponding to an organized event represented by a unique event code. Further, the processing device 202 may be configured for creating a user profile based on user data.

Further, the system 200 may include a communication device 204 configured for receiving, a unique institution identifier associated with an institution of the plurality of institutions from a user device associated with the user. Further, the communication device 204 may be configured for receiving a user identifier from the user device. Further, the user identifier may be associated with the user.

In further embodiments, an event code associated with an event being held at an institution of the plurality of institutions may be received from a user device associated with the user. Further, the communication device 204 may be configured for receiving the event code from the user device.

Further, the communication device 204 may be configured for transmitting an electronic form to the user device. Further, the electronic form may be configured to be presented on the user device. Further, the communication device 204 may be configured for receiving a filled electronic form from the user device. Further, the filled electronic form may include the user data corresponding to the user.

In some embodiments, the user data may include each of a contact information and a plurality of identifying characteristics associated with the user.

In some embodiments, the user data may include biometric data of the user. Accordingly, the processing device 202 may be configured for identifying the user based on the biometric data. For example, the communication device 204 may be configured for transmitting the biometric identifier to an external database. Further, the external database may include additional user data such as, for example, but not limited to, contact information and identifying characteristics. Moreover, the additional user data may be stored in the external database in association with the biometric identifier. Accordingly, the communication device 204 may be configured for receiving the additional user data from the external database. Further, the user profile may be generated based on the additional user data.

Further, the system 200 may include a storage device 206 configured for storing the user profile in association with the unique institution identifier and the unique event code in a database of user profiles.

In some embodiments, the storage device 206 may be further configured for searching the database of user profiles based on the user identifier. Further, the processing device 202 may be further configured for determining an absence of the user profile associated with the user based on the searching. Further, transmitting of the electronic form may be based on determining the absence.

In some embodiments, the communication device 204 may be further configured for transmitting a telephone number to the user device. In an embodiment, the transmitting of the telephone number is limited to a physical region associated with the institution. Accordingly, as the user approaches a stall corresponding to the institution and/or is present in the vicinity of the stall, the user device may receive the telephone number over a short-range communication channel such as, but not limited to, Bluetooth.

Alternatively, in another embodiment, the telephone number may be displayed, using a display device, installed proximal to the physical region associated with the institution. For example, a digital sign board may be installed near the stall. Further, the digital sign board may be communicatively coupled with the communication device. Accordingly, the digital sign board may receive the telephone number and display the same. As a result, the user who may be present at and/or near the stall may be able to view the telephone number thus displayed and accordingly send the text message addressed to the telephone number.

The communication device 204 may be further configured for receiving a text message addressed to the telephone number from the user device. Further, the text message may include the unique identifier associated with the institution of the plurality of institutions.

In some embodiments, the communication device 204 may be further configured for receiving a request from the user device. Further, the request may include at least one institution identifier of the plurality of institution identifiers. Additionally, the communication device 204 may be configured for transmitting information associated with the at least one institution identifier to the user device based on the request. In some embodiments, in addition to and/or instead of the information, the communication device 204 may be configured for provisioning of at least one of a product and a service to the user based on the request.

In some embodiments, transmitting the electronic form may include transmitting a text message including a web link corresponding to the electronic form. Further, the text message may be configured to be presented on the user device.

In some embodiments, the plurality of institutions may include a plurality of academic institutions. Further, the plurality of institution identifiers may include a plurality of College Entrance Examination Board (CEEB) codes associated with the plurality of academic institutions.

In some embodiments, the processing device 202 may be further configured for generating data analytics based on a plurality of user profiles associated with the unique institution identifier. In some embodiments, the data analytics may include a list of user identifiers associated with each institution of the plurality of institutions. Accordingly, an institution, such as for example, a college may be enabled to download the list of user identifiers corresponding to users who have expressed interest in the college. Further, in an instance, the institution may be enabled to download the list of user identifiers based on an authentication performed by the online platform (e.g. using login and password credentials). In some other embodiments, the processing device 202 may be further configured for monitoring of the user device within a venue associated with the event in order to determine a user behavior associated with the user. The user behavior may be based on, for example, a position of the user device, movement of the user device and body language of the user as captured by the user device. Accordingly, the user may include one or more sensors (e.g. location sensor, motion sensor, gesture detector, facial expression detector, biometric sensor such as heart rate sensor, blood pressure sensor etc.). As a result, the behavior of the user such as, but not limited to, visiting of one or more stalls in the venue, a time duration corresponding to the visiting, an interest level and/or an attention level expressed by the user towards the one or more stalls and so on may be determined.

Further, the communication device 204 may be further configured for transmitting the data analytics to an institution device associated with the unique institution identifier.

In some embodiments, the communication device 204 may be further configured for transmitting the unique institution identifier to the user device. Further, the transmitting may be limited to a physical region associated with the institution. Accordingly, a localized transmission of radio waves may be generated using one or more transmitters with predetermined radiation patterns. For example, one or more RF antennas placed at and/or near a stall associated with the institution may transmit the unique institution identifier using low energy radiation (e.g. low energy Bluetooth). Accordingly, the user device may be able to receive such transmission only when the user device is located proximal to the stall and/or located within the stall.

In some embodiments, the system 200 may further include a display device configured for displaying the unique institution identifier.

In some embodiments, the user data may include biometric data associated with the user. Further, the storage device 206 may be further configured for retrieving additional user data based on the biometric data. Further, the generating of the user profile may be based on the additional user data.

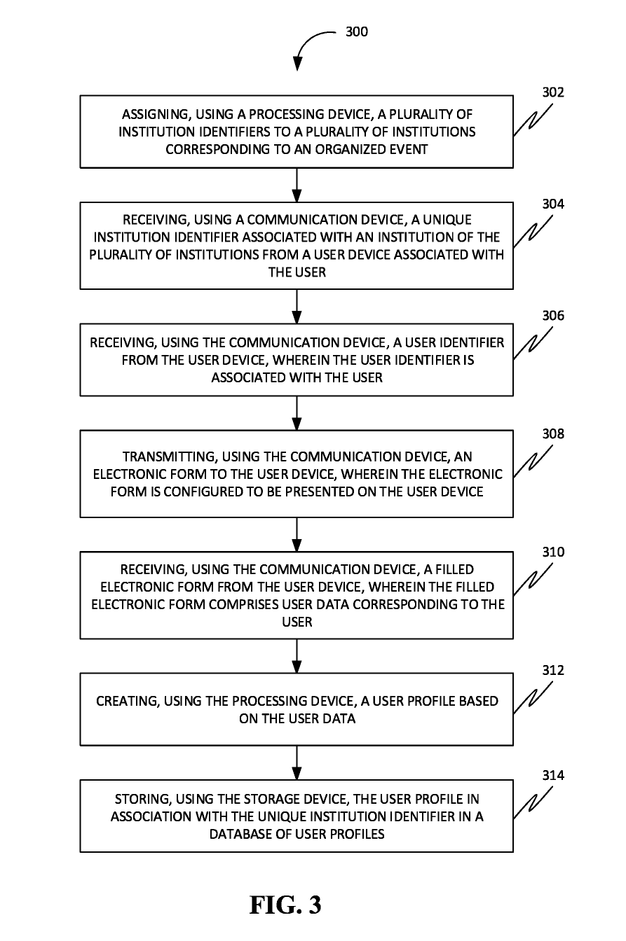

FIG. 3 is a flowchart of a method 300 of facilitating registration of a user in accordance with some embodiments. At 302, the method 300 may include assigning, using a processing device, a plurality of institution identifiers to a plurality of institutions corresponding to an organized event represented by a unique event code. In some embodiments, the plurality of institutions may include a plurality of academic institutions. Further, the plurality of institution identifiers may include a plurality of College Entrance Examination Board (CEEB) codes associated with the plurality of academic institutions.

Further, at 304, the method 300 may include receiving, using a communication device, a unique institution identifier associated with an institution of the plurality of institutions from a user device associated with the user. Further, at 306, the method 300 may include receiving, using the communication device, a user identifier from the user device. Further, the user identifier may be associated with the user.

Further, at 308, the method 300 may include transmitting, using the communication device, an electronic form to the user device. Further, the electronic form may be configured to be presented on the user device. In some embodiments, transmitting the electronic form may include transmitting a text message including a web link corresponding to the electronic form. Further, the text message may be configured to be presented on the user device.

Further, at 310, the method 300 may include receiving, using the communication device, a filled electronic form from the user device. Further, the filled electronic form may include user data corresponding to the user. The user data (via the electronic form) may be collected in real-time.

In some embodiments, the user data may include each of contact information and a plurality of identifying characteristics associated with the user.

In some embodiments, the user data may include biometric data of the user.

Accordingly, the method may include a step of identifying the user based on the biometric data. For example, the method may include a step of transmitting the biometric identifier to an external database. Further, the external database may include additional user data such as, for example, but not limited to, contact information and identifying characteristics. Moreover, the additional user data may be stored in the external database in association with the biometric identifier. Accordingly, the method may include the step of receiving the additional user data from the external database. Further, the user profile may be generated based on the additional user data.

Further, at 312, the method 300 may include creating, using the processing device, a user profile based on the user data. Further, at 314, the method 300 may include storing, using the storage device, the user profile in association with the unique institution identifier and the unique event code in a database of user profiles.

In some embodiments, the method 300 may further include transmitting, using the communication device, the unique institution identifier to the user device. Further, the transmitting may be limited to a physical region associated with the institution. Further, the method 200 may include generating a localized transmission of radio waves using one or more transmitters with predetermined radiation patterns. For example, one or more RF antennas placed at and/or near a stall associated with the institution may transmit the unique institution identifier using low energy radiation (e.g. low energy Bluetooth). Accordingly, the user device may be able to receive such transmission only when the user device is located.

In some embodiments, the method 300 may further include displaying, using a display device, the unique institution identifier.

In some embodiments, the user data may include biometric data associated with the user. Further, the method further may include retrieving, using the storage device, additional user data based on the biometric data. Further, the generating of the user profile may be based on the additional user data.

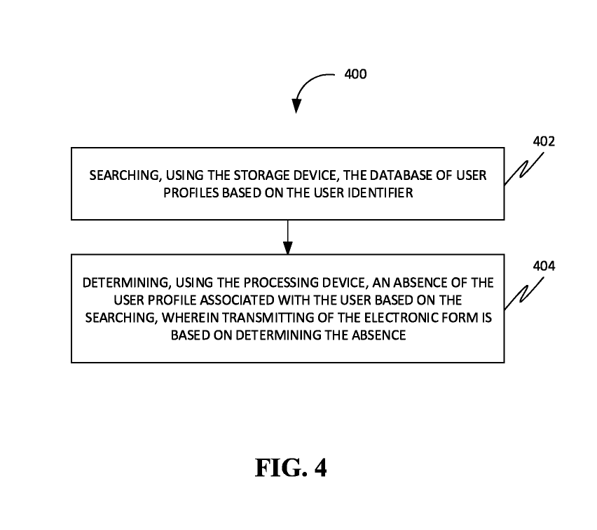

FIG. 4 is a flowchart of a method 400 of searching users accordance with some embodiments. At 402, the method 400 may include searching, using the storage device, the database of user profiles based on the user identifier. Further, at 404, the method 400 may include determining, using the processing device, an absence of the user profile associated with the user based on the searching. Further, transmitting of the electronic form may be based on determining the absence.

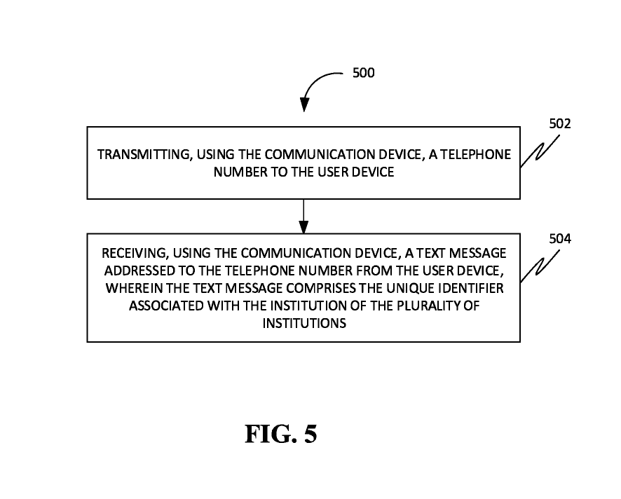

FIG. 5 is a flowchart of a method 500 of receiving text messages related to institutions in accordance with some embodiments. At 502, the method 500 may include transmitting, using the communication device, a telephone number to the user device. In an embodiment, the transmitting of the telephone number may be limited to a physical region associated with the institution. Accordingly, as the user approaches a stall corresponding to the institution and/or is present in the vicinity of the stall, the user device may receive the telephone number over a short-range communication channel such as, but not limited to, Bluetooth.

Alternatively, in another embodiment, the telephone number may be displayed, using a display device, installed proximal to the physical region associated with the institution. For example, a digital sign board may be installed near the stall. Further, the digital sign board may be communicatively coupled with the communication device. Accordingly, the digital sign board may receive the telephone number and display the same. As a result, the user who may be present at and/or near the stall may be able to view the telephone number thus displayed and accordingly send the text message addressed to the telephone number.

Further, at 504, the method 500 may include receiving, using the communication device, a text message addressed to the telephone number from the user device. Further, the text message may include the unique identifier associated with the institution of the plurality of institutions.

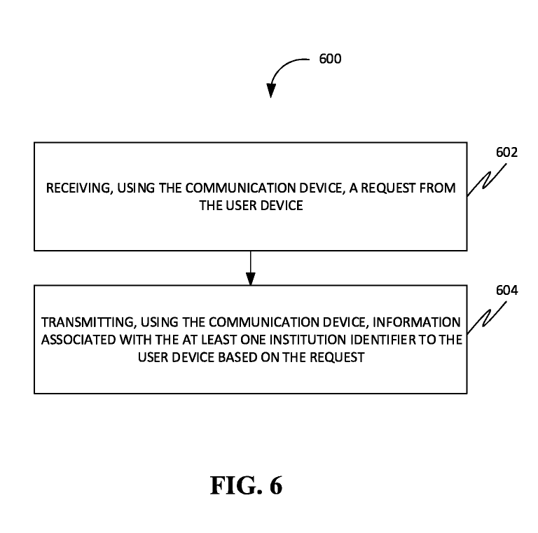

FIG. 6 is a flowchart of a method 600 of sending information related to institutions to users in accordance with some embodiments. At 602, the method 600 may include receiving, using the communication device, a request from the user device. Further, the request may include at least one institution identifier of the plurality of institution identifiers. Additionally, at 604, the method 600 may include transmitting, using the communication device, information associated with the at least one institution identifier to the user device based on the request. In some embodiments, in addition to and/or instead of information, the method may include provisioning of at least one of a product and a service to the user based on the request.

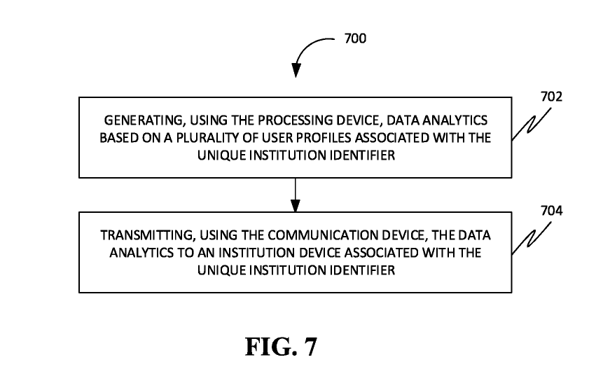

FIG. 7 is a flowchart of a method 700 of obtaining data analytics in accordance with some embodiments. At 702, the method 700 include generating, using the processing device, data analytics based on a plurality of user profiles associated with the unique institution identifier.

In some embodiments, the data analytics may include a list of user identifiers associated with each institution of the plurality of institutions. In some other embodiments, the method may include monitoring of the user device within a venue associated with the event in order to determine a user behavior associated with the user. The user behavior may be based on, for example, a position of the user device, movement of the user device and body language of the user as captured by the user device. Accordingly, the user may include one or more sensors (e.g. location sensor, motion sensor, gesture detector, facial expression detector, biometric sensor such as heart rate sensor, blood pressure sensor etc.). As a result, the behavior of the user such as, but not limited to, visiting of one or more stalls in the venue, a time duration corresponding to the visiting, an interest level and/or an attention level expressed by the user towards the one or more stalls and so on may be determined.

At 704, the method 700 includes transmitting, using the communication device, the data analytics to an institution device associated with the unique institution identifier.

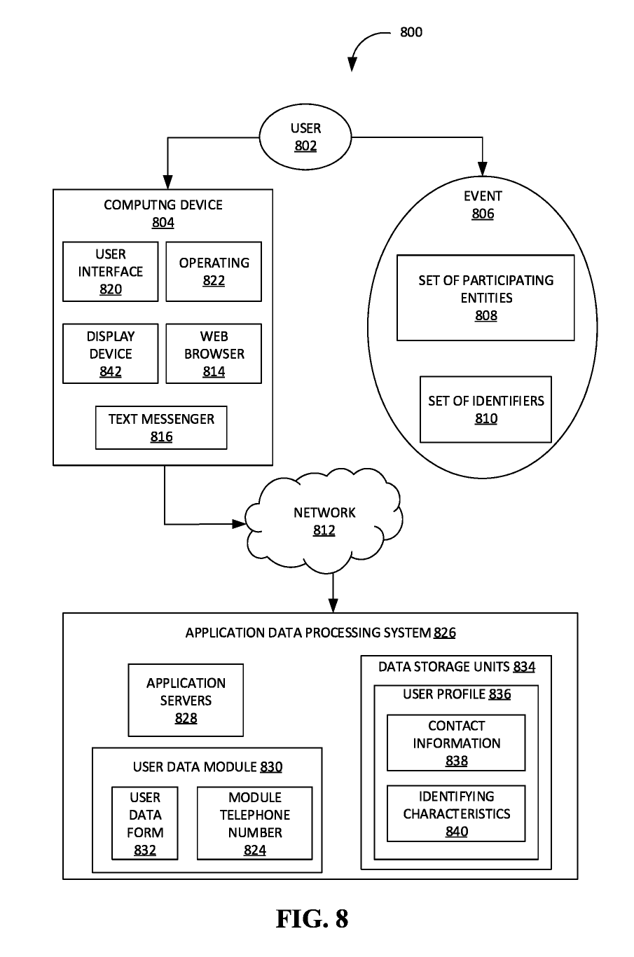

FIG. 8 is a block diagram of an exemplary system 800 for collecting user data from a user (e.g. user 802) who is attending or participating in an event, such as an event 806, in accordance with some embodiments. The data may be collected in real-time. As used herein, an event (including the event 806) may be any type of organized event that is intended to connect one or more users with participating entities attending the event. Examples of the event 806 may include, but are not limited to, college fairs, job or career fairs, trade shows, military recruitment fairs, fairs and community activities with a focus on non-profit organizations. Other examples of organized events may include any type of conference or presentation with a focus on one or more businesses or organizations that are featured at the conference or presentation and the special programs and services that they offer.

Additional examples of organized events may include large or small gatherings for sporting and/or entertainment purposes. Therefore, the event 806 may be a sporting event that includes, but is not limited to, football, basketball, soccer, hockey, baseball, volleyball, gymnastics, swimming, or any type of sport played anywhere in the world. Therefore, the event 806 may include any type of sporting event regardless of whether the sport is played by professional athletes and regardless of the type of sport.

The event 806 may further include entertainment events such as, but not limited to, performances of any type or genre, and may include any type of concert or performance that the public may want to attend. The event 806 may include entertaining performances provided by professional and non-professional entertainers that also may include music, singing, and/or dancing, or other exhibitions of art.

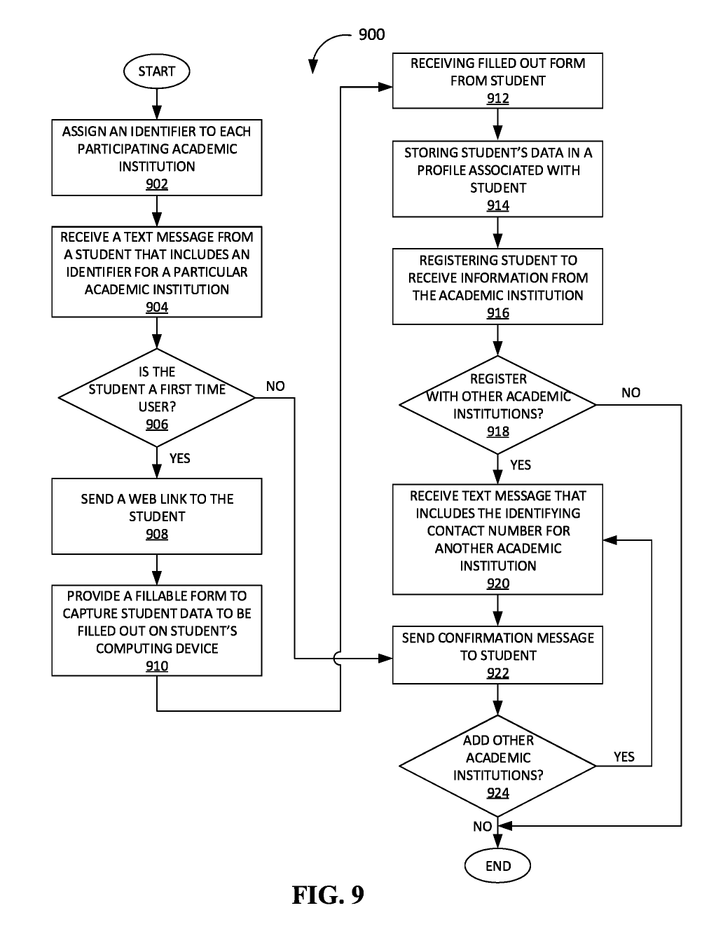

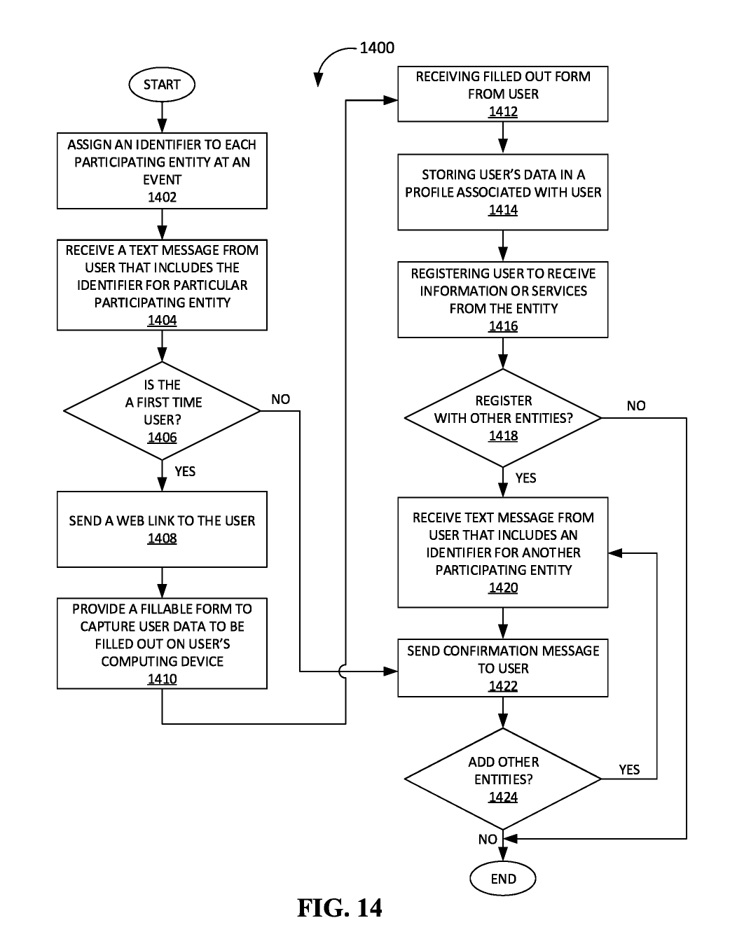

To clarify, it is an object of the present description to facilitate the collection of user data from a large group of users that attend an organized event in a manner that is fast, accurate, efficient, and not a cumbersome process. As described further below in FIG. 9 and FIG. 14, one or more embodiments of a method allow the user to sign up one time to store his or her contact information (e.g. contact information 838) or other identifying characteristics (e.g. identifying characteristics 840) in a user profile 836 that is stored and associated with the user 802. Thereafter, any time the user 802 desires to sign up to either receive information and/or request services provided by a participating entity of a set of participating entities 808 at the event 806, the user 802 will experience a simplified, more efficient way that the student may share his or her contact information with the participating entity of interest.

The set of participating entities 808 may be any type of entity that may desire to attend and participate in the event 806. The set of participating entities 808 may include any type of business or organization, including for-profit or non-profit organizations. Further, the set of participating entities 808 may include academic institutions of any type or size or location. The term “academic institution” as used herein may refer to any college (including community colleges), university, training programs, vocational programs, of any type having any type of certification or credentialing. Such academic institutions may be related to any type of academic courses or programs. Academic institutions may also include vocational or technical colleges that focus on training and educating for any type of job or skill, including, but not limited to skilled trades such as, but not limited to, electricians, cosmetologists, construction workers, nurses and medical staff, welders, carpenters, painters, etc.

For many of the organized events listed above (e.g. college fairs, career fairs, community service event fairs, trade shows, etc.) there are possibly hundreds or thousands of people attending who wish to find out more information and/or register to be included in the contact lists and database for particular entities, such as the set of participating entities 808. Further, the individuals who attend such organized events may also want to sign up to receive particular services offered by these specific institutions and entities that are also attending and participating in the organized event. Accordingly, it is to be understood that the event 806 may be a coordinated, organized event that involves planning and preparation to contact each entity from the set of participating entities 808 to attend and be hosted at the event 806.

Further, the event 806 involves a level of participation from a participating entity at the organized event that desires to intentionally collect contact information and other data about attendees (e.g. invitees, guests, customers, recruits, etc.) who come to the organized event. Subsequently, the goal of the participating entity at the organized event may be to store the user contact information and other relevant user data for these attendees in any type of storage or data entry system that the participating entity has in place so that the participating entity can share and stay in touch with the attendees who expressed interest in that participating entity.

The information subsequently shared by the participating entity with the attendee may be in whatever format known in the art, including a digital format (e.g. email messages, text messages, links to social media accounts) as well as a non-digital format (print media such as flyers, brochures, and documents). Further, the information that is shared in a digital format may be sent via email, text, or any other electronically available means for sharing information. The information shared by the participating entity with the attendee in a non-digital format may be shared using any means available in the art including via regular post office mail or another form of delivery to a physical address.

In one non-limiting embodiment, each participating entity of the set of participating entities 808 may have an assigned table or booth at the event 806. In particular, if the event 806 is a college fair, it is standard that each participating college or academic institution that is participating may have a designated spot at the event 806. Therefore, each college or other academic institution may have its own booth for prospective students to approach the college representatives who are located at the booth. Likewise, job fairs, community service fairs, sporting events that have vendors may include one or more booths, tables, kiosks, or other designated areas for each participating entity of the set of participating entities 808 to share their respective information and/or provide goods or services to the user 802.

In one or more embodiments, the user 802 may be an attendee of the event 806. The term “attendee” as used herein may also interchangeably be used to mean guest, invitee, customer, ticketholder, fan, recruit, or client depending on the particular context including the type of the event 806 that the user 802 is actually attending. For example, the user 802 may be a ticket holder and/or fan if the event 806 is a sporting event or concert. In another example, the user 802 may also be referred to as a “client” of a business or non-profit organization that qualifies as a participating entity among the set of participating entities 808 located at the event 806.

Further, the user 802 is associated with at least one computing device in that the user 802 is an owner or operator of a computing device 804. At the very least, the user 802 has privileges and rights to use the computing device 804 even if the user 802 does not directly own the computing device 804 (e.g. as in the case where the computing device 804 is a smartphone given to a user by his or her workplace).

The computing device 804 may be any type of computing device known in the art, including portable and/or non-portable computing devices. A user may carry, wear or otherwise transport the computing device 804. The computing device 804 may include any type of digital electronic data processing device, including any type of cellular phones. “Cellular phones” as used herein may include smartphones and feature phones (i.e. not smartphones). The computing device 804 may also include, but is not limited to, tablets, laptops, personal computers, wearable smartwatches or other wearable technology, and personal digital assistants (PDAs).

Further, non-portable computing devices may include desktop computers or other fixed non-portable computing devices. For example, in one exemplary embodiment, a fixed non-portable computing device may be a fixed computer located in the same venue as the event 806, whereby the user 802 has access to the fixed non-portable computing device and may use the non-portable computing device to access a network 812 and a user data module 830.

In a non-limiting embodiment whereby the computing device 804 is a smartphone or table, any type of smartphone or table known in the art may be utilized, including, but not limited to, iPhones and iPads manufactured by Apple. Such smartphones and tablets may also include Galaxy smartphones provided by Samsung, Droid Razr phones provided by Motorola, as well as smartphones associated with LG to name a few. The computing device 804 also includes smartphones and tablets that operate on the Google Android operating system.

The computing device 804 may include a vast number of components that are known in the art. The computing device 804 may necessarily include one or more processors, memory, communication channels and interfaces, as well as computer readable media readers and computer readable media. For purposes of simplification, a few useful components of the computing device 804 are described below, but with the understanding that additional components known in the art and required to operate the computing device 804 may also be present.

The computing device 804 may include an operating system, such as operating system 822. The operating system 822 may be adapted to operate one or more systems, modules, or components located on the computing device 804. The operating system 822 may be a mobile or non-mobile type of operating system. Mobile operating systems as described herein may be operating systems configured particularly for smartphones, tablets, or other mobile devices, whereas non-mobile operating systems may be operating systems configured for non-mobile computing devices (ex. desktop computers).

The operating system 822 may be any type of operating system available to one of ordinary skill in the art, including, but not limited to, versions of the Microsoft Windows operating systems, versions of the Google Android operating system, the different releases of the Unix and Linux operating systems, any version of the Mac OS for Macintosh computers or iOS for Macintosh smartphones, operating systems provided by Google Android, as well as any embedded operating system, any real-time operating system, any open source operating system, or any other operating system capable of running on the computing device 804 and performing the operations associated with the computing device 804 as well as operations described herein.

Further, the computing device 804 may include any type of user interface 820 or display device 842. In one or more embodiments, the user interface 820 may comprise, without limitation thereto, a keyboard. The keyboard may be connected to the computing devices 804 through a cable or wire. The keyboard may also be connected via Bluetooth or a Wi-Fi Internet connection. Additionally, or alternatively, such a keyboard may be a touch screen simulated keyboard that is included with various smart phones, tablets, and computers. By utilizing the user interface 820 associated with the computing device 804, the user 802 can enter data (e.g. digital data) into one or more modules or components included on the computing device 804.

The display device 842 may be a display device adapted for the user 802 to interact with and adapted for displaying information to the user 802, including images or text. The display device 842 may be any type of display device known in the art, including, without limitation, a screen capable of generating an image or text. Accordingly, the display device 842 may be implemented as a computer monitor, a touch screen, a liquid crystal display (LCD) screen, a plasma screen, mobile phone display screen, an optical head-mounted display, or any other type of display device known in the art.

The computing device 804 may further include web browser 814. The web browser 814 may be any type of web browser known in the art that may be used to access one or more web applications on user the computing device 804. Web applications are applications that are accessible by the network 812 and may be located on the Internet. The web browser 814 may include hardware, software, and/or firmware generally operative to present a web application to the user 802 via the display device 842 (e.g. touchscreen or other type of computer monitor). Examples of suitable web browsers include Microsoft Explorer, Mozilla Firefox, and Apple Safari, without limitation thereto. The web browser 814 may be previously installed by the manufacturer or company associated with the computing device 804, or alternatively, may be downloaded onto the computing device 804.

The computing device 804 may further include text messenger 816. The text messenger 816 is a software module that dispatches and receives text messages that may be displayed on the computing device 804 via the display device 842. Text messages may include electronic messages, typically consisting of alphabetic and numeric characters, between two or more users of mobile phones, fixed devices (e.g., desktop computers) or portable devices (e.g., tablet computers or smartphones). As used herein, the term “module” may refer to any type of software application.

The text messenger 816 may be included as a standard application that is installed on the computing device 804. Modern portable digital computing devices, (e.g.

smartphones, tablets, wearable watches, personal computers) readily include text messaging applications that may serve as the text messenger 816. The text messenger 816 may be adapted to support any text messaging protocols known to one of ordinary skill in the art including, but not limited to, FAX, GSMAT, SMTP, SNPP, TAP, TONE, UCP, and WCTP. Further, the text messenger 816 may be adapted for network sending of Short Message Service (SMS) messages. SMS is a text messaging service component of most telephone, World Wide Web, and mobile telephony systems. It uses standardized communication protocols to enable computing devices to exchange short text messages. SMS texts generally include alphanumeric text as opposed to multimedia messages (known as MMS), which contain digital images, videos, and sound content, as well as ideograms known as Emoji (happy faces and other icons).

Further, the computing device 804 may be communicatively connected to the network 812. In one or more embodiments, the network 812 may include a local area network (LAN), such as a company Intranet, a metropolitan area network (MAN), or a wide area network (WAN), such as the Internet or World Wide Web. The network 812 may be a private network or a public network, or a combination thereof. The network 812 may be any type of network known in the art, including telecommunications network, a wireless network (including Wi-Fi), and a wireline network. The network 812 may include mobile telephone networks utilizing any protocol or protocols used to communicate among mobile digital computing devices (e.g. the computing device 804), such as GSM, GPRS, UMTS, AMPS, TDMA, or CDMA. In some embodiments, different type of data may be transmitted via the network 812 via different protocols.

Further, the system 800 may further include application data processing system 826. The application data processing system 826 may include hardware, software, and/or firmware generally operative to present the user data module 830 to the user 802. The application data processing system 826 may interact with user the computing device 804 via the network 812.

The application data processing system 826 may include application servers 828. In some embodiments, the application servers 828 may include multiple, logically-grouped servers. In one of these embodiments, the logical group of servers may be referred to as a server farm or a machine farm. In another of these embodiments, the application servers 828 may be geographically dispersed. In other embodiments, a machine farm may be administered as a single entity. In still other embodiments, the machine farm may include a plurality of machine farms. The application servers 828 within each machine farm can be heterogeneous, whereby one or more of the servers or machines within the application servers 828 can operate according to one type of operating system platform (for example purposes only, Windows NT), while one or more of the other servers within the application servers 828 can operate on or according to another type of operating system platform (e.g., Unix or Linux).

In one embodiment, the application servers 828 in the machine farm may be stored in high-density rack systems, along with associated storage systems, and located in an enterprise data center. However, the application servers 828 of each machine farm do not need to be physically proximate to another server in the same machine farm. Therefore, the application servers 828 may be logically grouped as a machine farm that may be interconnected using a wide area network (WAN) connection or a metropolitan area network (MAN) connection. For example, a machine farm may include servers physically located in different locations (including different geographic locations). Additionally, management of the machine farm may be de-centralized. The application servers 828 may be a set of servers that may be a file server, application server, web server, proxy server, appliance, network appliance, gateway, gateway server, virtualization server, deployment server, or SSL VPN server.

In one or more embodiments, the user data module 830 is accessible via the network 812. The user data module 830 is a type of software application that may also be interchangeably referred to as a “web application” and/or “cloud application”. A web application as used herein refers to applications (i.e. computer programs that include software modules) that are retrievable by the user 802 using his or her computing device 804 via the network 812. Typically, a web-based application and/or cloud application, such as the user data module 830, is not stored or located on the computing device 804. Rather, a web-based application or cloud-based application is accessible by a user who sends and receives requests and or digital data from the cloud or web application via the network 812. Cloud computing is an Internet-based method of computing in which various resources are provided to users (e.g. the user 802) over the Internet from a “cloud”. A “cloud” as used herein may refer to a group of servers (e.g. application servers 838) that contain various resources that are hosted by a third party. The servers (e.g. application servers 838) are computer hardware running computer software products that are designed to deliver the various resources to the users.

It is noted that in some embodiments, the network 812 may include access to the World Wide Web (i.e. Internet) via wireless networks, such as Wi-Fi, or via cellular networks associated with user the computing device 804. Cellular networks may refer to the voice and data cellular networks that have been established by various telecommunications service providers. Examples of such telecommunications service providers include, but are not limited to, AT&T, T-Mobile, Verizon, Sprint, or any other telecommunication server provider known in any geographic location without restriction thereto. In particular, if the computing device 804 is a mobile computing device, the computing device 804 may be adapted to transmit digital data (e.g. voice, text, images) via cellular towers that have been associated with a particular telecommunication service provider. The cellular or mobile telephone networks may use any protocol to communicate and transfer data between mobile computing devices and other mobile or non-mobile computing devices (e.g. the application servers 828), including, but not limited to, GSM, GPRS, UMTS, CDMA, TDMA, and AMPS. It is noted that it may be preferred for the user 802 to utilize a Wi-Fi operating network (i.e. the network 812 may include a Wi-Fi operating network) that may be available in the venue or location associated with the event 806 to avoid data charges and fees that are often part of transmitting data via cellular networks.

Therefore, a third party may host the user data module 830 on the application servers 828 with the object of collecting and storing user profiles 836. The user profiles 836 may be stored on a variety of data storage units associated with the application data processing system 826.

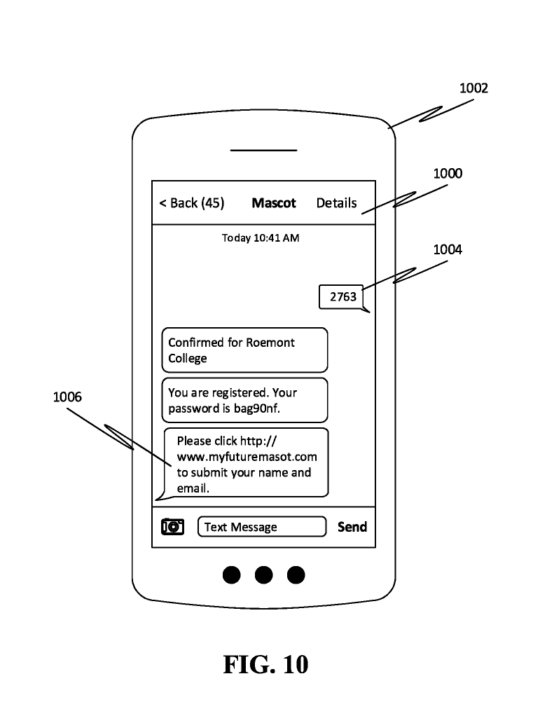

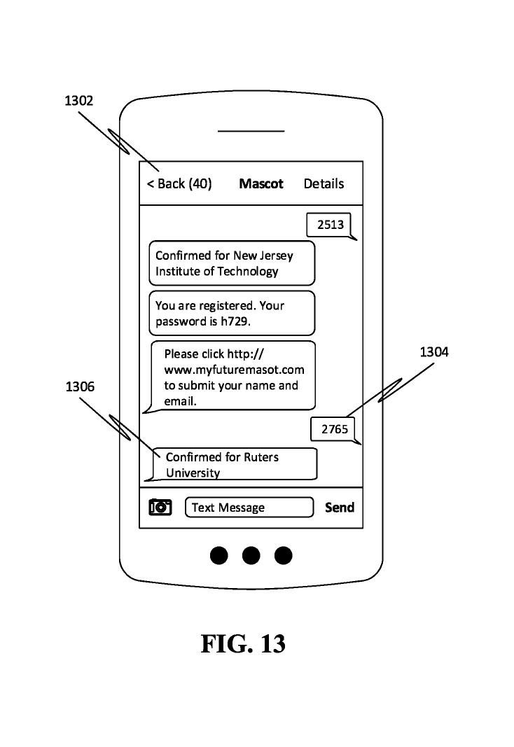

It is noted that the user data module 830 may be associated with a website (not shown in FIG. 8) having its own web address. As further discussed below, upon signing up and creating a user profile, a student may be provided with a login ID and password (e.g. as shown in FIG. 10 and FIG. 13) that allows him or her to access a database associated with the website and to view or edit the student's user profile. Further, the user 802 may be able to see which participating entities of the set of participating entities 808 the user 802 is registered or subscribed with.

The user profiles 836 may include the contact information 838 and other identifying characteristics 840 of the user 802. The user profiles 836 may be a profile of the user 802 that includes relevant data about the user 802. The contact information 838 may include one or more telephone numbers, email addresses, and physical addresses of the user 802, or a combination thereof. At a basic level, the contact information 838 may at least include user's name, telephone, and/or email address. Other information may also be included in the user profiles 836 including the identifying characteristics 840. The identifying characteristics 840 may refer to any type of data related to a user. More specifically, the identifying characteristics 840 may be additional details about the user 802 that may be useful or beneficial for the set of participating entities 808 attending the event 806.

For example, if the event 806 is a college fair, it may be beneficial for the user profiles 836 to include the contact information 838 (e.g. such as telephone number, email address, physical address) as well as the identifying characteristics 840. Examples of the identifying characteristics 840 may include age of the user 802, height, gender, race or ethnicity. The identifying characteristics 840 may further include all academic institutions that the user 802 has or is currently attending. A high school student attending a college fair may include each high school or any additional colleges or other academic institutions that he or she has attended. However, it is true that people who have graduated high school and attended other colleges or academic institutions may also attend college fairs. Therefore, the identifying characteristics 840 may include a spot for any academic institution to be listed (e.g. using user data form 832). This may include high schools or other colleges or universities. Further, identifying characteristics may include data about the areas of study or work that a prospective student may be interested in (e.g. in particular where the event 806 is a college fair).

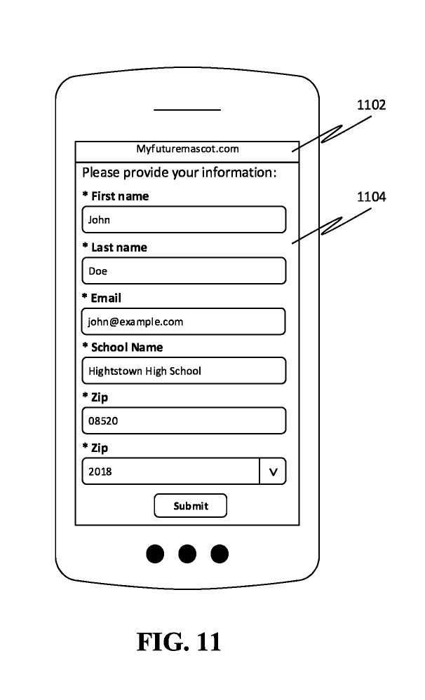

The user data module 830 may include a module for a user data form such as the user data form 832. The user data form 832, in one embodiment, may be provided to the user 802 by sending a text message with a web link that may be received by web browser, such as the web browser 814, on the computing device 804 (e.g. as shown in FIG. 10). The user data form 832 may include a web-based fillable form having a set of fields. The set of fields may include entry fields that a user may fill out, for example, using the user interface 820 along with the display device 842 on the computing device 804. The user data form 832 may include a set of fields for a user to enter the contact information 838 and other identifying characteristics (e.g. data) 840 about the user 802. FIG. 11 includes a non-limiting example of the user data form 832 that includes a set of fields for a user to fill out his or her the contact information 838 and other the identifying characteristics 840.

In one or more embodiments, the user 802 may send a text message (e.g. using the text messenger 816 on the user computing device 804) using module telephone number 824. The module telephone number 824 may be any type of telephone number known to one of ordinary skill in the art including, but not limited to, a city telephone number, national number, toll-free number, mobile number, and/or a shortcode.

A “shortcode” as used herein may mean a set of digits that are significantly shorter than standard telephone numbers. Shortcodes, as known in the art, are often used to address messages in the Multimedia Messaging System (MMS) and short message service (SMS) systems of mobile network operators. Shortcodes are easier to remember by the public because there are usually less numbers that an individual has to utilize (e.g. may be only about 4 to 6 digits in length).

In addition to the above, the system 800 includes a set of identifiers 810 that are associated with the set of participating entities 808. Specifically, each participating entity 808 may be assigned a unique identifier from the set of identifiers 810. Therefore, each identifier from the set of identifiers 810 that is associated with each participating entity may be used as a unique code to identify each participating entity.

Each identifier is therefore specifically assigned to a particular participating entity such that the identifier is not usually shared between two or more participating entities (unless a group of participating entities so desires). In one non-limiting embodiment, the set of identifiers 810 may be a combination of alphanumeric characters. Additionally, or alternatively, the set of identifiers 810 may take any form known in the art and may include one or more Emojis, icons, or other visual symbols.

In one exemplary non-limiting embodiment, if the set of participating entities 808 include academic institutions (e.g. colleges or universities or other training or vocational program), the set of identifiers 810 associated with each participating academic institution may be the College Entrance Examination Board (CEEB) code associated with each academic institution. A CEEB code, as known to those of ordinary skill in the art, is a standardized identification number that is assigned to a high school, college, or university by the College Entrance Examination Board. Therefore, for example, the CEEB code associated with New Jersey Institute of Technology is “2513”, while the CEEB code for the Houston Community College is “0929”. The colleges and universities usually have a four (4) digit CEEB code, whereas high schools usually have six (6) digit CEEB codes.

It may be preferable in cases where the set of participating entities 808 include one or more academic institutions to use CEEB codes as the set of identifiers 810, because each academic institution may easily have prior knowledge of and readily obtain this information. It is quite likely that the college admissions staff and representatives, including recruiters, who may be attending a college fair (e.g. the event 806) will not have difficulty remembering a 4-digit CEEB code as the unique identifier associated with the respective academic institution.

Therefore, in one or more embodiments, the user 802 may be provided with the module telephone number 824 when the user 802 arrives at the event 806. In one exemplary application, each participating entity of the set of participating entities 808 may have a booth or table at the event 806. Each participating entity may display the module telephone number 824 on his or her booth, table, kiosk, or other designated area at the event 806. In one or more non-limiting examples, the module telephone number 824 may be displayed on one or more signs located above or near a booth or other designated area for each participating entity of the set of participating entities 808. Additionally, the module telephone number 824 may be provided on pens, drink cups, or other exemplary promotional material provided by representatives of the participating entity 808. Further, the module telephone number 824 may be included on one or more web addresses, social media accounts, or printed materials provided by a participating entity in the set of participating entities 808.

In addition, each participating entity of the set of participating entities 808 may also advertise or make the user 802 aware of the unique identifier of the set of identifiers 810 that has been assigned to each participating entity. In related aspects to the description just provided for the module telephone number 824, representatives for participating entity of the set of participating entities 808 may use any means, including, but not limited to, displaying signage and/or printing or otherwise locating the unique identifier 810 on any goods or materials (printed or digital) associated with the participating entity.

FIG. 9 is a flowchart for an exemplary method 900 for collecting student data and registering users to receive information from participating academic institutions attending an event in accordance with some embodiments. The non-limiting steps of the method 900 may utilize one or more components of the system 800.

A student is attending an event, such as, but not limited to a, a college fair, where he or she desires to share his or her contact information and other related user data with one or more colleges or other types of academic institutions. The term “student” as used herein may broadly and interchangeably refer to a prospective student as well as a currently enrolled student. Further, there is no limitation to the age of the student or how much education or previous degrees that the student may have earned prior to attending an organized event. Further, a student implementing the exemplary process in FIG. 9 may be interested in attending an event to obtain a broad array of information from a particular academic institution that is represented and attending an event (such as the event 806).

The “information” that may be provided by an academic institution and that may be of interest to a student, includes, but is not limited to, information related to any courses, programs (including graduate and undergraduate programs), curriculum, degrees, specialties, campus size and layout, athletic teams, or housing or other accommodations associated with the particular academic institution, as well as any other type of information that may be of interest to the student.

In one or more embodiments, the method 900 may be applicable for participating academic institutions at an organized event in accordance with the event 806 as shown in FIG. 8 and as described above. Accordingly, student/user is an attendee at a college fair for example. The student may approach a table or booth for a particular college. Rather, than requiring the student to go to the table, wait in a line, and manually fill out an information card or other type of sign-in sheet, (as is the traditional approach at college fairs), the user or student is able to utilize one or more steps of the method 900.

At step 902, the method 900 may begin (or at least include) assigning an identifier with each participating academic institution. At step 904, a student may send a text message that includes an identifier, such as the unique identifier for a participating academic institution. Notably, in one or more embodiments, prior to step 902 or in addition to step 902, a phone number in accordance with the module telephone number 824 is distributed and made known to a student, whereby the module telephone number 824 is associated with a user data module, such as the user data module 830.

Therefore, in one or more embodiments, a student may send a text message by first entering the module telephone number 824 in the “To” field provided in the text messenger 816 and as known in the art. In one or more embodiments, the student is enabled to send and receive text messages (including SMS and MMS text messages) over the network 812 using one or more applications on the student's computing device, such as, but not limited to, the text messenger 816 shown in the system 800 in FIG. 8. Further, text messages, including the text message received by the system at step 904, may be transmitted using one or more protocols on the network 812 described above with respect to FIG. 8.

FIG. 10 is a user interface 1000 (on a smartphone 1002) related to confirmation messages received in a process for collecting student data and registering students with specific colleges of interest in accordance with an exemplary embodiment. A student has the smartphone 1002 (e.g. the computing device 804) to text an identifier associated with a particular academic institution of interest to the student. As noted above, FIG. 10 includes a 4 digit CEEB code that is utilized as the identifier for the particular academic institution that a student is interested in receiving information from.

As shown in the example in FIG. 10, the student sends a text 1004 “2763” to the phone number (e.g. the module telephone number 824) that has been previously provided to the student, whereby “2763” is the actual CEEB code associated with Rosemount College, which is a college located in Rosemount, Pennsylvania. In this example, in FIG. 10, the student is interested in sharing his or her contact information with Rosemount College and receiving return information or material about Rosemount College.

The method 900 may continue with a determination whether the student is a first time user (the step 906). To clarify, the system may determine whether the student has a user profile (e.g. the user profiles 836) already created that is also associated with one or more identifying elements of the user's computing device that is used to send the first text message of the step 904.

In one or more embodiments, the system creates a user profile that associates a particular telephone number or other identifier from a user computing device with a particular user and/or student profile. In terms of being a first time user, the system may ask the user to associate his or her computing devices each time if the user computing device has a different phone number or other identifying number than what exists in the system. In one or more embodiments, it may be possible for a user to associate multiple computing devices with his or her user profile such as the user profiles 836. Alternatively, in other embodiments, a user may be restricted to a single computing device, including to a single type of computing device for registering his or her user profile data. For example, in some non-limiting embodiments, a user may only be able to utilize a specific smartphone if the user wants to utilize a module, such as the user data module 830 shown in FIG. 8 and described above, as well as to implement on or more steps shown in FIG. 9 or one or more steps shown in FIG. 14 and described later below. If the student is a first time user, then the system may send a web link 1006 to the student (step 908). Alternatively, if the student is not a first time user, then the system proceeds to step 922 which is discussed further below.

The web link 1006 may be sent to the student at step 908 over a communications network such as the network 812. The web link 1006 may be received by a web browser application include in the student's computing device, such as, for example, the web browser 814. The web link 1006 may direct the student to a user data form that may be provided to capture student data that may be filled out using one or more components of the student's computing device (step 910). The user data form may be in accordance with the user data form 832. Accordingly, the user data form may include a set of data entry fields dedicated to receiving specific types of a student's contact information or other identifying characteristics. FIG. 10 shows an exemplary text message that is returned to a student's computing device that includes the exemplary web link 1006 that selected for accessing the user data form.

FIG. 11 is a user interface 1102 related to an exemplary fillable user data form 1104 for receiving student data in accordance with an exemplary embodiment. The user data form 1104 may include fillable fields for receiving basic contact information about the student, including the student's first and last name, email address, zip code (or entire physical address). The form 1104 further requests additional information that may be categorized as additional identifying characteristics (i.e. data) about the student, because the form 1104 depicted in FIG. 11 requests the anticipated graduation year of the student.

Those of ordinary skill in the art will appreciate that the images shown in FIGS. 10 and 11 (or other figures) are merely exemplary and meant to be illustrative, rather than limiting. In other embodiments, additional or fewer fields may be included in the user data form 1104 to request additional or fewer pieces of student-related contact information and data. Further, the form 1104 may take alternative shapes, appearances, and include any additional information that a participating entity would like to include in such a form.

At step 912, the method 900 continues with receiving the completed student data form, which may be submitted by the student. More specifically, in one embodiment, upon entering the data requested in the user data form 1104 (e.g. the user data form 832), the student may select a “Submit” icon as shown in FIG. 11 (or other similar button or icon) to submit the completed user data form. Beneficially, it is an advantage provided by the method described herein that the user is allowed to enter (e.g. via typing or voice-activated commands) his or her contact information and other data into the form 1104 directly. This should reduce the number of errors, including spelling and errors in transcribing a user's telephone or email address that currently occur when college recruiters collect and transcribe the information that is handwritten by students on conventional information collection cards.

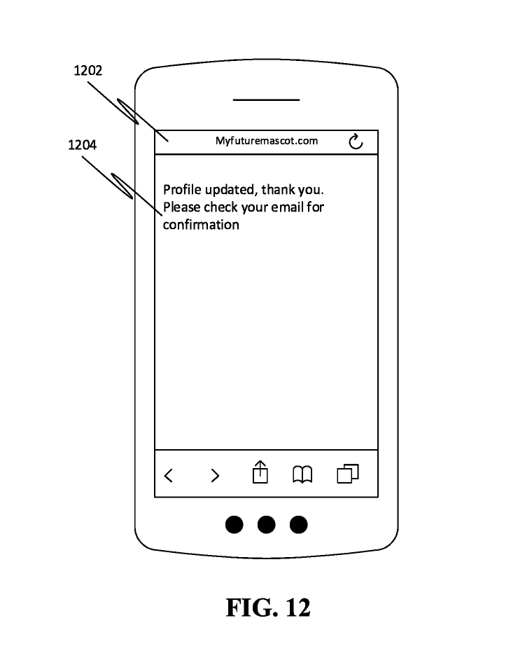

At step 914 the student's data may be stored and associated with a specific student profile. The student profile may be in accordance with the user profiles 836 shown in FIG. 8 and described above. Referring to FIG. 12, FIG. 12 is a user interface 1202 related to an exemplary confirmation message 1204 in accordance with an exemplary embodiment. As shown in FIG. 12, in one or more embodiments, the process may include providing a notification to the student that their profile has been updated. Further, the process may include the text message 1204 provided to the student asking the student to check their email address for confirmation of the registration of their user profile, which is illustrated in FIG. 12.

Accordingly, the process may include setting up a user profile that is made available to the student upon its creation. In one or more embodiments, the user may access the user profile using a password that is initially provided to the student, such as the exemplary passwords illustrated in FIG. 10. At step 916, the method 900 may continue by registering a student to receive information from the particular academic institution associated with the unique identifier that was included in the first text message sent by the student at step 904.

The system may determine whether the student would like to proceed with registering for any other academic institutions (step 918). In one exemplary embodiment, an associated user data module, such as the user data module 830 (or other system component) may send a follow-up a text message to student's computing device asking whether the student would like to register for any additional entities (not shown).

Alternatively, as shown in FIG. 9, the system may be notified that the student desires to register with other academic institutions by receiving a second or additional text messages from the student that include an identifier for each additional participating academic institution with which the student is interested in associating (step 920). Accordingly, the student may send and one or more data processing units in the implementing system (e.g. the application data processing system 826) may receive a text message whereby the student provides the same module telephone number (e.g. the module telephone number 824) in the “To” field of the text messaging application on the student's computing device (e.g. the computing device 804).

Further, the student may include the unique identifier associated with an additional academic institution of interest to the student in the body or message field of the text message application of the student's computing device. In one example, as noted above, the additional academic institution may be assigned its CEEB code as its unique identifier.

Upon receiving the text messages from the user for the second or additional academic institutions at step 920, the method 900 may proceed with sending a confirmation message to the student confirming receipt of their text message (step 922).

FIG. 13 is a user interface 1302 related to a registered student receiving confirmation of registration with another college after an initial student profile is created in accordance with an exemplary embodiment. Further, non-limiting confirmation message that is sent to the student (e.g. via text) that they are confirmed registered subscribers for information provided for a particular academic institution. As shown in the particular example in FIG. 13, the student sent a text message 1304 that included the CEEB code of Rutgers University in the body of the text message. In return, the system provided a confirmation message 1306 that they are “confirmed,” (e.g. registered). In other words, upon confirmation may mean that the student's user profile (including contact information) has been or will be provided to this specific academic institution in due course. Accordingly, the academic institution may implement its known practices for contacting a registered student who has expressed interest in receiving additional information from the academic institution.

The method 900 may continue with determining whether the student would like to register for additional academic institutions (step 924). If not, the method 900 terminates. However, if the system receives additional text messages, then the method 900 may return to the steps 920-922 in a continuous loop until no further text messages are sent by the student and received by the system.

Upon completion of the college fair event or other organized event for participating academic institutions as shown in FIG. 8, the present system has a complete user profile for each participating student. The assembled user profile may include basic information about each student (e.g. name, email address, phone number, age, areas of academic or vocational interest, and/or high school), as well as a list of the academic institutions that each student is interested in receiving informational material from (or other services).

In one or more embodiments, the system may then share the respective collected data with the participating students and academic institutions. Further, the system may even share the data and information with the student's high school. In one of the embodiments, the system may provide each student the entire list of the colleges or other academic institutions that he or she has shown an interest in by sending this information via email to the student. Alternatively, in another embodiment, the student is provided with his account login id and password so that the student may access a database that includes a record of all the academic institutions with which the student has registered or subscribed. Accordingly, in some embodiments, the user may have an account on a provided website that includes this information.

The system may also be enabled to share, with each participating academic institution, the list of all the students who are interested in receiving informational material from that particular college. The shared list may include all the informational data collected in the student profile of each interested student. In one of the embodiments, the system shares the user profile information via email, whereby the user profile is provided as an attachment or embedded within an email. Alternatively, the user profiles may be collected into a spreadsheet and emailed as an attachment or embedded within an email sent to the participating academic institution. Alternatively, in another embodiment, as soon as the system receives interest from any student for a particular academic institution and receives the student's filled out user data form, the system may share the filled out user data form 1104 with the respective academic institution of interest. Those of ordinary skill in the art will understand that alternative methods and techniques may be used for sharing user and/or student profiles with participating institutions and/or entities.

FIG. 14 is a flowchart of an exemplary method 1400 for collecting user data and registering users to receive information or services from participating entities at an event in accordance with some embodiments. The method 1400 may be applicable to a wide range of entities, including businesses and organizations, regardless of whether the businesses and organizations are for-profit or not for profit. Further, the method 1400 may be useful for any type of organized event. Notably, the organized event around which FIG. 14 is centered may be in accordance with the description of the event 806 provided above and shown in FIG. 8. The steps provided in FIG. 14 are similar to steps 902-924 shown in FIG. 9 and provided above with respect to a student registering to receive information and an academic institution collecting student user data.

In FIG. 14, the method 1400 may begin with step 1402 whereby an identifier is assigned to each participating entity at an event. At step 1404, the implementing system may receive a text message from a user that includes the identifier assigned to the particular participating entity. The method 1400 may continue by making a determination whether this is a first time user (step 1406). If the user is not a first time user, the method 1400 may continue to step 1422. Alternatively, if the user is a first time user, then the method 1400 may continue by sending the user a web link (step 1408).

The method 1400 may continue by providing a fillable form to be filled out on a user's computing device (step 1410). Subsequently, the system may receive the filled out user data form from the user (step 1412). The method 1400 may further include storing the user's data in a profile associated with the user (1414). The method 1400 may further include registering the user to receive information and/or services from the respective entity (1416). The method 1400 may then make a determination whether the student has indicated an interest to continue registering and sharing his or her contact information with other entities (step 1418). If the answer is no, then the method 1400 is terminated.

Alternatively, text messages may be received by the system from the user that includes additional identifiers associated with additional participating entities at the organized event (step 1420). The method 1400 may then proceed by sending confirmation messages to the user (step 1422). Subsequently, the method 1400 may proceed to determine whether the user would like to register with additional entities or to terminate the method 1400 (at step 1424).

Numerous advantages and benefits are provided by one or more embodiments of the system and methods shown and described in the present description. Users may readily and quickly share a user profile that they create with numerous entities of interest to the user without having to continuously fill out the same information repeatedly. Further, the users may have access to view their user profiles and update them as needed. For example, when a user changes his or her phone number or would like to include additional fields of relevant data, the user may do so by accessing a website associated with a user data module, such as the user data module 830 shown in FIG. 8. Additionally, when the user sends a text message, the user's telephone number is known and verified as a working number for use by the participating entity or institution.

With respect to the example provided above for college fairs, numerous advantages are provided by one or more embodiments of this method and system. No longer does the recruiter or staff have to worry about losing information collection cards or not being able to read or decipher what has been handwritten on the cards. Further, given that the vast majority of prospective, college-bound students' own smartphones (or other operating digital computing devices), one or more embodiments of the method and system provided in the present disclosure do not require any special equipment that a student is not already likely to have. In addition, students can readily implement the steps of the methods for providing his or her contact information and identifying characteristics using a standard version of the text messaging application and web browser that are already installed or included on his or her smartphone (or like device).

One or more embodiments of the present description is likely to eliminate or at least significantly reduce the time and expense associated with trying to obtain correct student contact information as well as the time and expense associated with sending informational material to the student that is then not delivered or returned due to an error in an email or mailing address. In the embodiments described herein, a student is able to accurately type in his or her identifying contact information in a web-based form. Accordingly, the student who is most knowledgeable about his or her contact information is not likely to provide erroneous contact information or other data in the web-based form. The one or more embodiments of the described system and method is less time consuming and a more user-friendly process overall.

The user computing device 804 may include a variety of components as understood by one skilled in the art. The user computing device 804 may include one or more processors, including a microprocessor that may be coupled to a communications channel. The user computing device 804 may include additional input devices not discussed above (e.g. mouse, stylus). Further, a user may operate the user computing device 804 using any means known in the art including tactile touch or voice-activated commands. The user computing device 804 may include a communication interface, a data storage device (such as a magnetic or optical disk), and memory (such as random access memory (RAM), each coupled to the communications channel. The communication interface may be coupled to the network 812 in FIG. 8. One skilled in the art will recognize that the data storage device and memory may be different units or parts of the same unit, distributed units, virtual memory, etc. Further, it will be appreciated that the term “memory” herein is intended to cover all data storage media whether permanent or temporary.

One skilled in the art will also recognize that programs and data may be received by and stored in the user computing device 804 in alternative ways. For example, a computer-readable storage medium reader, such as a magnetic disk drive, magneto-optical reader, or CPU, may be coupled to the communications channel for reading a computer-readable storage medium, such as a magnetic disk, a hard disk, a magneto-optical disk, or RAM.

One skilled in the art will recognize that the system 800 shown in FIG. 8 may also include additional components, such as network connections, additional memory, additional processors, and input/output lines for transferring information across a hardware channel, the Internet, Intranet, or cellular networks. Connections may be wired, wireless, modem, without limitation thereto. The various embodiments set forth herein may be implemented utilizing hardware, software, or any desired combination thereof.

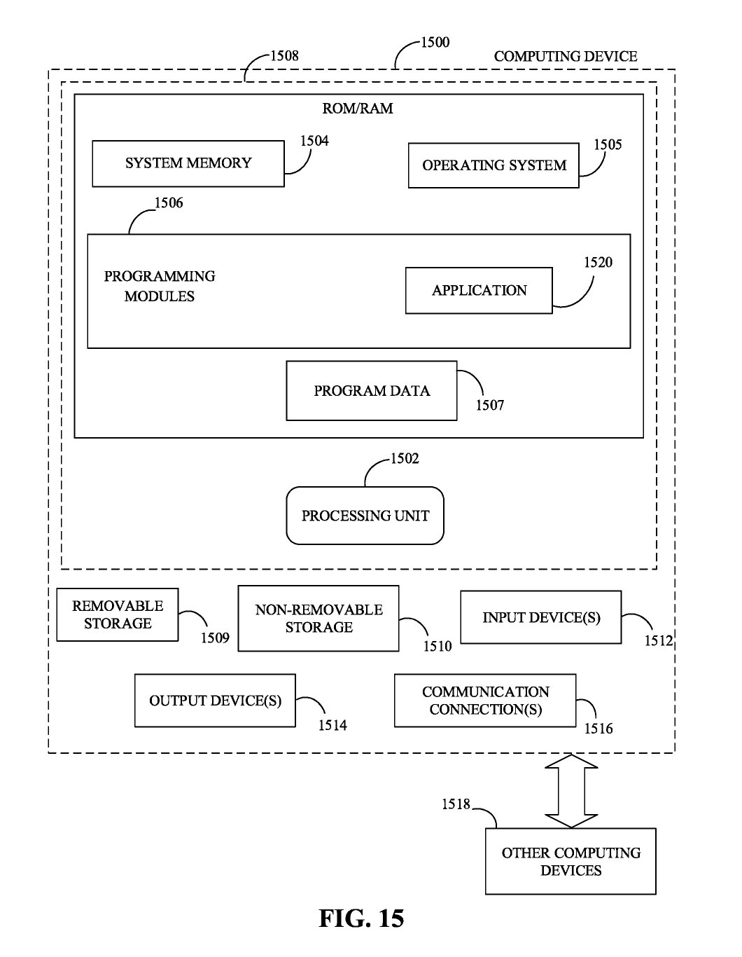

With reference to FIG. 15, a system consistent with an embodiment of the disclosure may include a computing device or cloud service, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random-access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500′s operation. In one embodiment, programming modules 1506 may include machine learning module. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and nonvolatile, removable and non-removable media implemented in any method or technology for storage of information, such as computer-readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, a location sensor, a camera, a biometric sensor, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., application 1520 such as a media player) may perform processes including, for example, one or more stages of methods, algorithms, systems, applications, servers, databases as described above. The aforementioned process is an example, and processing unit 1502 may perform other processes. Other programming modules that may be used in accordance with embodiments of the present disclosure may include data processing application, machine learning application, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the disclosure has been explained in relation to its preferred embodiment, it is to be understood that many other possible modifications and variations can be made without departing from the spirit and scope of the disclosure.

We claim:

1. A method of facilitating registration of a user, the method comprising:
assigning, using a processing device, a plurality of institution identifiers to a plurality of institutions corresponding to an organized event, wherein the organized event is associated with a unique event code;
receiving, using a communication device, a unique institution identifier associated with an institution of the plurality of institutions from a user device associated with the user;
receiving, using the communication device, a user identifier from the user device, wherein the user identifier is associated with the user;
transmitting, using the communication device, an electronic form to the user device, wherein the electronic form is configured to be presented on the user device;
receiving, using the communication device, a filled electronic form from the user device, wherein the filled electronic form comprises user data corresponding to the user;
creating, using the processing device, a user profile based on the user data; and
storing, using the storage device, the user profile in association with the unique institution identifier and the unique event code in a database of user profiles.

2. The method of claim 1 further comprising:
searching, using the storage device, the database of user profiles based on the user identifier;
determining, using the processing device, an absence of the user profile associated with the user based on the searching, wherein transmitting of the electronic form is based on determining the absence.

3. The method of claim 1 further comprising:
transmitting, using the communication device, a telephone number to the user device; and
receiving, using the communication device, a text message addressed to the telephone number from the user device, wherein the text message comprises the unique identifier associated with the institution of the plurality of institutions.

4. The method of claim 1 further comprising:
receiving, using the communication device, a request from the user device, wherein the request comprises at least one institution identifier of the plurality of institution identifiers; and
transmitting, using the communication device, information associated with the at least one institution identifier to the user device based on the request.

5. The method of claim 1, wherein transmitting the electronic form comprises transmitting a text message comprising a web link corresponding to the electronic form, wherein the text message is configured to be presented on the user device.

6. The method of claim 1, wherein the plurality of institutions comprises a plurality of academic institutions, wherein the plurality of institution identifiers comprises a plurality of College Entrance Examination Board (CEEB) codes associated with the plurality of academic institutions.

7. The method of claim 1 further comprising:
generating, using the processing device, data analytics based on a plurality of user profiles associated with the unique institution identifier; and
transmitting, using the communication device, the data analytics to an institution device associated with the unique institution identifier.

8. The method of claim 1 further comprising transmitting, using the communication device, the unique institution identifier to the user device, wherein the transmitting is limited to a physical region associated with the institution.

9. The method of claim 1 further comprising displaying, using a display device, the unique institution identifier.

10. The method of claim 1, wherein the user data comprises biometric data associated with the user, wherein the method further includes retrieving, using the storage device, additional user data based on the biometric data, wherein the generating of the user profile is based on the additional user data.

11. A system for facilitating registration of a user, the system comprising:
a processing device configured for:
assigning, using a processing device, a plurality of institution identifiers to a plurality of institutions corresponding to an organized event;
creating a user profile based on user data;
a communication device configured for:
receiving, using a communication device, a unique institution identifier associated with an institution of the plurality of institutions from a user device associated with the user;
receiving a user identifier from the user device, wherein the user identifier is associated with the user;
transmitting an electronic form to the user device, wherein the electronic form is configured to be presented on the user device;
receiving a filled electronic form from the user device, wherein the filled electronic form comprises the user data corresponding to the user; and
a storage device configured for storing the user profile in association with the unique institution identifier in a database of user profiles.

12. The system of claim 11, wherein the storage device is further configured for searching the database of user profiles based on the user identifier, wherein the processing device is further configured for determining an absence of the user profile associated with the user based on the searching, wherein transmitting of the electronic form is based on determining the absence.

13. The system of claim 11, wherein the communication device is further configured for:
transmitting a telephone number to the user device; and
receiving a text message addressed to the telephone number from the user device, wherein the text message comprises the unique identifier associated with the institution of the plurality of institutions.

14. The system of claim 11, wherein the communication device is further configured for:
receiving a request from the user device, wherein the request comprises at least one institution identifier of the plurality of institution identifiers; and
transmitting information associated with the at least one institution identifier to the user device based on the request.

15. The system of claim 11, wherein transmitting the electronic form comprises transmitting a text message comprising a web link corresponding to the electronic form, wherein the text message is configured to be presented on the user device.

16. The system of claim 11, wherein the plurality of institutions comprises a plurality of academic institutions, wherein the plurality of institution identifiers comprises a plurality of College Entrance Examination Board (CEEB) codes associated with the plurality of academic institutions.

17. The system of claim 11, wherein the processing device is further configured for generating data analytics based on a plurality of user profiles associated with the unique institution identifier, wherein the communication device is further configured for transmitting the data analytics to an institution device associated with the unique institution identifier.

18. The system of claim 11, wherein the communication device is further configured for transmitting the unique institution identifier to the user device, wherein the transmitting is limited to a physical region associated with the institution.

19. The system of claim 11 further comprising a display device configured for displaying the unique institution identifier.

20. The system of claim 11, wherein the user data comprises biometric data associated with the user, wherein the storage device is further configured for retrieving additional user data based on the biometric data, wherein the generating of the user profile is based on the additional user data.
